(19) United States
(12) Patent Application Publication
(10) Pub. No.: US 2024/0128500 A1
(43) Pub. Date: Apr. 18, 2024

(54) SOLID ELECTROLYTE, METHOD OF PREPARING THE SAME, POSITIVE ELECTRODE, AND ALL-SOLID-STATE RECHARGEABLE BATTERY

(71) Applicants: SAMSUNG SDI CO., LTD., Yongin-si (KR); HYUNDAI MOTOR COMPANY, Seoul (KR); KIA CORPORATION, Seoul (KR)

(72) Inventors: Suk-Gi HONG, Yongin-si (KR); Myeongju HA, Yongin-si (KR); Hwichul YANG, Yongin-si (KR); Pilsang YUN, Yongin-si (KR); Hyungbeom KIM, Yongin-si (KR); Young Gyoon RYU, Yongin-si (KR); Kyusung PARK, Yongin-si (KR); Saheum KIM, Hwaseong-si (KR); Yongjun JANG, Hwaseong-si (KR); Yonggu KIM, Hwaseong-si (KR); Sungman CHO, Hwaseong-si (KR); Sunho CHOI, Hwaseong-si (KR); Seonghyeon CHOI, Hwaseong-si (KR)

(21) Appl. No.: 18/378,907

(22) Filed: Oct. 11, 2023

(30) Foreign Application Priority Data
Oct. 14, 2022 (KR) 10-2022-0132690

(51) Int. Cl. H01M 10/0562; H01M 4/62; H01M 10/0525

(52) U.S. Cl. CPC H01M 10/0562; H01M 4/62; H01M 10/0525; H01M 2004/028; H01M 2300/008; H01M 2300/0094

(57) ABSTRACT

A solid electrolyte, including sulfide-based solid electrolyte particles and a coating layer disposed on the surface of the sulfide-based solid electrolyte particles and including a metal alkoxide.

### CROSS-REFERENCE TO RELATED APPLICATION

This application claims priority to and the benefit of Korean Patent Application No. 10-2022-0132690 filed in the Korean Intellectual Property Office on Oct. 14, 2022, the entire contents of which are incorporated herein by reference.

### BACKGROUND

### 1. Field

Embodiments relate to solid electrolytes, methods of preparing the same, positive electrodes, and all-solid-state rechargeable batteries.

### 2. Description of the Related Art

Recently, as the risk of explosion of a battery using a liquid electrolyte has been reported, development of an all-solid-state rechargeable battery has been actively conducted. An all-solid-state rechargeable battery refers to a battery in which all materials are solid, and in particular, a battery using a solid electrolyte. This all-solid-state rechargeable battery may be safe with no risk of explosion due to leakage of the electrolyte and also easily prepared into a thin battery.

### SUMMARY

Embodiments are directed to a solid electrolyte, including sulfide-based solid electrolyte particles and a coating layer disposed on a surface of the sulfide-based solid electrolyte particles and including a metal alkoxide.

In embodiments the metal alkoxide may include a metal, and the metal may include one or more elements selected from Nb, Sb, Ti, V, or Zr.

In embodiments an amount of the metal alkoxide may be about 0.1 wt % to about 50 wt % based on 100 wt % of the solid electrolyte.

In embodiments an amount of the metal alkoxide may be about 5 wt % to about 25 wt % based on 100 wt % of the solid electrolyte.

In embodiments the coating layer may further include a metal oxide containing the same metal as the metal of the metal alkoxide.

In embodiments a thickness of the coating layer may be about 5 nm to about 1 μm.

In embodiments the sulfide-based solid electrolyte particles may include an argyrodite-type sulfide.

In embodiments the argyrodite-type sulfide may include Li₃PS₄, Li₇PS₆, Li₆PS₅Cl, Li₆PS₅Br, Li_{5.8}PS_{4.8}Cl_{1.2}, Li_{6.2}PS_{5.2}Br_{0.8} or a combination thereof.

In embodiments an average particle diameter (D50) of the solid electrolyte may be about 0.1 μm to about 5.0 μm.

Embodiments are directed to a method of preparing a solid electrolyte, the method including adding sulfide-based solid electrolyte particles to a solution including a metal alkoxide and a solvent to mix them, removing the solvent, and drying a product obtaining a solid electrolyte including sulfide-based solid electrolyte particles and a coating layer disposed on a surface of the particles and including a metal alkoxide.

In embodiments the metal alkoxide may include a metal, and the metal may include one or more elements selected from Nb, Sb, Ti, V, or Zr.

In embodiments a content of the metal alkoxide may be about 0.1 parts by weight to about 50 parts by weight based on 100 parts by weight of the sulfide-based solid electrolyte particles.

In embodiments a content of the metal alkoxide may be about 5 parts by weight to about 25 parts by weight based on 100 parts by weight of the sulfide-based solid electrolyte particles.

In embodiments the solvent may include pentane, hexane, heptane, benzene, toluene, xylene, acetic acid, diethyl ether, ethyl acetate, pyridine, or a combination thereof.

In embodiments the sulfide-based solid electrolyte particle may include an argyrodite-type sulfide.

In embodiments the argyrodite-type sulfide may include Li₃PS₄, Li₇PS₆, Li₆PS₅Cl, Li₆PS₅Br, Li_{5.8}PS_{4.8}Cl_{1.2}, Li_{6.2}PS_{5.2}Br_{0.8} or a combination thereof.

In embodiments the drying may be performed at about 20° C. to about 70° C.

In embodiments an average particle diameter (D50) of the obtained solid electrolyte may be about 0.1 μm to about 5.0 μm.

In embodiments a positive electrode for an all-solid-state rechargeable battery may include the solid electrolyte and a positive electrode active material.

In embodiments an all-solid-state rechargeable battery, may include a positive electrode, a negative electrode, and a solid electrolyte layer between the positive electrode and the negative electrode, wherein the positive electrode and/or the solid electrolyte layer may include the solid electrolyte.

### BRIEF DESCRIPTION OF THE DRAWINGS

Features will become apparent to those of skill in the art by describing in detail exemplary embodiments with reference to the attached drawings in which:

FIGS. 1 and 2 show schematic cross-sectional views of an all-solid rechargeable battery according to some example embodiments; and

FIG. 3 is a graph of cycle-life characteristics of all-solid-state rechargeable battery cells to which a solid electrolyte was applied after being left for 3 days in Example 1 and Comparative Example 1.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The singular expression includes the plural expression unless the context clearly dictates otherwise.

As used herein, “combination thereof” means a mixture, laminate, composite, copolymer, alloy, blend, reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In addition, “layer” herein includes not only a shape formed on the whole surface when viewed from a plan view, but also a shape formed on a partial surface.

In addition, the average particle diameter may be measured by a method well known to those skilled in the art, for example, may be measured by a particle size analyzer, or may be measured by a transmission electron microscopic photograph or a scanning electron microscopic photograph. Alternatively, it is possible to obtain an average particle diameter value by measuring it using a dynamic light scattering method, performing data analysis, counting the number of particles for each particle size range, and calculating from this. The average particle diameter may be measured by a microscope image or a particle size analyzer, and may mean a diameter (D50) of particles having a cumulative volume of 50 volume % in a particle size distribution.

Herein, “or” is not to be construed as an exclusive meaning, for example, “A or B” is construed to include A, B, A+B, and the like.

Solid Electrolyte

Some example embodiments may provide a solid electrolyte including sulfide-based solid electrolyte particles and a coating layer disposed on the surface of the sulfide-based solid electrolyte particles and containing metal alkoxide.

The metal alkoxide may be a material capable of being easily coated on the sulfide-based solid electrolyte particles at room temperature without a separate heat treatment and effectively suppressing the problems of generating defects on the surface of the sulfide-based solid electrolyte particles during the coating. The coating layer including the metal alkoxide may lower the interfacial resistance in the battery as well as effectively protect the sulfide-based solid electrolyte particles which are vulnerable to moisture to improve efficiency and cycle-life characteristics of all-solid-state rechargeable batteries.

In the metal alkoxide, the metal may include one or more element, e.g., Nb, Sb, Ti, V, or Zr. In an implementation, the metal alkoxide may be vanadium alkoxide, niobium alkoxide, or antimony alkoxide. These metal alkoxides may be easily coated on the surface of the sulfide-based solid electrolyte particles at room temperature, may effectively protect the surface without adversely affecting the sulfide-based solid electrolyte particles, may effectively suppress interfacial resistance between solid electrolyte particles or between a solid electrolyte and other solid particles within a battery, and may positively affect electron conduction and ion conduction within the battery.

In the metal alkoxide, the alkoxide may be, e.g., an alkoxide having about 1 to about 20 carbon atoms, an alkoxide having about 1 to about 10 carbon atoms, or an alkoxide having about 1 to about 6 carbon atoms. In an implementation, the alkoxide may be methoxide, ethoxide, propoxide, isopropoxide, n-butoxide, t-butoxide, and the like.

The metal alkoxide may be, e.g., vanadium oxytriethoxide (VO(OCH₂CH₃)₃), vanadium oxytriisopropoxide (VO(OCH(CH₃)₂)₃), vanadium oxytripropoxide (VO(O(CH₂)₂CH₃)₃), niobium ethoxide (Nb(OCH₂CH₃)₅), niobium n-butoxide (Nb(O(CH₂)₃CH₃)₅), antimony ethoxide (Sb(OCH₂CH₃)₃), antimony Propoxide (Sb(O(CH₂)₂CH₃)₃), antimony isopropoxide (Sb(OCH(CH₃)₂)₃), titanium ethoxide (Ti(OCH₂CH₃)₄), titanium propoxide (Ti(O(CH₂)₂CH₃)₄), titanium isopropoxide (Ti(OCH(CH₃)₂)₄), zirconium ethoxide (Zr(OCH₂CH₃)₄), zirconium propoxide (Zr(O(CH₂)₂CH₃)₄), zirconium isopropoxide (Zr(OCH(CH₃)₂)₄), or a combination thereof.

A content of the metal alkoxide may be about 0.1 wt % to about 50 wt %, e.g., about 1 wt % to about 40 wt %, about 5 wt % to about 40 wt %, or about 10 wt % to about 40 wt %, and as one example, it may be about 5 wt % to about 25 wt % based on 100 wt % of the solid electrolyte. In addition, a metal content of the metal alkoxide may be about 0.1 at % to about 10 at %, e.g., about 0.5 at % to about 5 at % or about 1 at % to about 5 at %, and as one example, it may be about 0.1 wt % to about 2.5 wt % based on the total amount of the solid electrolyte. If the metal alkoxide is included in the above content range, the surfaces of the sulfide-based solid electrolyte particles may be effectively protected without adversely affecting moisture stability and interfacial resistance may be lowered, thereby improving the performance of the solid electrolyte.

Meanwhile, the metal alkoxide may be changed into a metal oxide form by causing a hydrolysis reaction in a solid electrolyte coating or transfer process, in a battery manufacturing process, or in contact with air or moisture inside a manufactured battery. Accordingly, in addition to the metal alkoxide, the coating layer may further include a metal oxide.

The metal of the metal oxide can be said to be the same as that of the coated metal alkoxide. The metal oxide may be, e.g., vanadium oxide, niobium oxide, antimony oxide, titanium oxide, or zirconium oxide.

The coating layer may be in the form of a continuous film or in the form of an island, and may cover the entire surface of the sulfide-based solid electrolyte particle or a portion thereof.

The thickness of the coating layer may be approximately about 5 nm to about 1 μm, e.g., about 5 nm to about 300 nm, about 10 nm to about 200 nm, or about 10 nm to about 100 nm. If the coating layer is uniformly formed on the surfaces of the sulfide-based solid electrolyte particles within the thickness range, the performance of the all-solid-state rechargeable battery may be improved because the moisture stability of the solid electrolyte may be improved and the interfacial resistance may be lowered.

The sulfide-based solid electrolyte particle may include a general sulfide-based solid electrolyte compound, e.g., Li₂S—P₂S₅, Li₂S—P₂S₅—LiX (wherein X may be a halogen element, e.g., I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—B₂S₃, Li₂S—P₂S₅—ZₘSₙ (wherein m and n may each be an integer, respectively, and Z may be Ge, Zn or Ga.), Li₂S—GeS₂, Li₂S—SiS₂—Li₃PO₄, Li₂S—SiS₂-LipMO_{q} (wherein p and q are integers, and M may be P, Si, Ge, B, Al, Ga, or In), or a combination thereof.

Such a sulfide-based solid electrolyte may be obtained by, e.g., mixing Li₂S and P₂S₅ in a molar ratio of about 50:50 to about 90:10 or about 50:50 to about 80:20 and optionally performing a heat-treatment. Within the above mixing ratio range, a sulfide-based solid electrolyte having excellent ion conductivity may be prepared. The ion conductivity may be further improved by adding SiS₂, GeS₂, B₂S₃, and the like as other components thereto.

Mechanical milling or a solution method may be applied as a mixing method of sulfur-containing raw materials for preparing a sulfide-based solid electrolyte. The mechanical milling is to make starting materials into particulates by putting the starting materials, ball mills, and the like in a reactor and fervently stirring them. The solution method may be performed by mixing the starting materials in a solvent to obtain a solid electrolyte as a precipitate. In addition, in the case of heat-treatment after mixing, crystals of the solid electrolyte may be more robust and ion conductivity may be improved. In an implementation, the sulfide-based solid electrolyte may be prepared by mixing sulfur-containing raw materials and performing a heat treatment two or more times. In this case, a sulfide-based solid electrolyte having high ion conductivity and robustness may be prepared.

In an implementation, the sulfide-based solid electrolyte particles may include argyrodite-type sulfide. The argyrodite-type sulfide may be, e.g., represented by the chemical formula, LiₐM_{b}P_{c}S_{d}Aₑ (wherein a, b, c, d, and e may each be 0 or more and 12 or less, M may be Ge, Sn, Si, or a combination thereof, and A may be F, Cl, Br, or I), and as a specific example, it may be represented by the chemical formula of Li₇₋ₓ,PS₆₋ₓ, Aₓ (wherein x may be 0.2 or more or 1.8 or less, and A may be F, Cl, Br, or I). Specifically, the argyrodite-type sulfide may be Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, and the like.

The sulfide-based solid electrolyte particles including such argyrodite-type sulfide may have high ion conductivity close to the range of about 10′ to about 10'S/cm, which is the ion conductivity of general liquid electrolytes at room temperature, and may form an intimate bond between the positive electrode active material and the solid electrolyte without causing a decrease in ion conductivity, and furthermore, an intimate interface between the electrode layer and the solid electrolyte layer. An all-solid-state battery including the same may have improved battery performance such as rate capability, coulombic efficiency, and cycle-life characteristics.

The argyrodite-type sulfide-based solid electrolyte may be prepared, e.g., by mixing lithium sulfide and phosphorus sulfide, and optionally lithium halide. A heat treatment may be performed after mixing them. The heat treatment may include, e.g., two or more heat treatment steps.

An average particle diameter (D50) of the sulfide-based solid electrolyte particles according to some example embodiments may be less than or equal to about 5.0 μm, e.g., about 0.1 μm to about 5.0 μm, about 0.1 μm to about 4.0 μm, about 0.1 μm to about 3.0 μm, about 0.1 μm to about 2.0 μm, or about 0.1 μm to about 1.5 μm. The sulfide-based solid electrolyte particles may be small particles with an average particle diameter (D50) of about 0.1 μm to about 1.0 μm or may be large particles with an average particle diameter (D50) of about 1.5 μm to about 5.0 μm depending on the location or purpose of use. The sulfide-based solid electrolyte particles having this particle size range can effectively penetrate between solid particles in a battery, and have excellent contact with an electrode active material and connectivity between solid electrolyte particles. The average particle diameter of the sulfide-based solid electrolyte particles may be measured using a microscope image, and, e.g., a particle size distribution may be obtained by measuring the size of about 20 particles in a scanning electron microscope image, and D50 may be calculated therefrom.

Preparing Method of Solid Electrolyte

In some example embodiments, the preparing method of a solid electrolyte may include adding sulfide-based solid electrolyte particles to a solution including a metal alkoxide and a solvent to mix them, removing the solvent and drying a product to obtain a solid electrolyte including sulfide-based solid electrolyte particles and a coating layer disposed on the surface of the particles and including a metal alkoxide.

The preparing method of the solid electrolyte may be a wet coating method, and unlike dry coating, defects are not generated on the surface of the sulfide-based solid electrolyte particles during the mixing process. In addition, since a sufficient coating effect may be obtained through a drying process after the wet coating and a separate heat treatment may not be performed, particle aggregation or occurrence of defects on the particle surface due to heat treatment may be suppressed.

Since the metal alkoxide and the sulfide-based solid electrolyte particles are the same as those described above, detailed descriptions thereof will be omitted.

The solvent may be a non-polar organic solvent, and may include, e.g., pentane, hexane, heptane, benzene, toluene, xylene, acetic acid, diethyl ether, ethyl acetate, pyridine, or a combination thereof.

In the preparing method, a content of the metal alkoxide may be about 0.1 part by weight to about 50 parts by weight, e.g., about 1 part by weight to about 40 parts by weight, about 5 parts by weight to about 40 parts by weight, or about 10 parts by weight to about 40 parts by weight based on 100 parts by weight of the sulfide-based solid electrolyte particles. If the metal alkoxide is mixed within such an amount, a stable and uniform coating layer may be effectively formed on the surface of the solid electrolyte.

The drying may be performed at about 20° C. to about 65° C., e.g., about 20° C. to about 45° C., or about 20° C. to about 35° C., and, e.g., it may be dried at room temperature. Through the drying process, a coating layer may be stably and uniformly formed on the surface of the sulfide-based solid electrolyte particles, and in the process, defects or corrosion may not be generated on the surface of the sulfide-based solid electrolyte particles, so that a solid electrolyte with excellent performance may be prepared.

Positive Electrode for All-solid-state Rechargeable Battery

A positive electrode for an all-solid-state rechargeable battery may include a current collector and a positive electrode active material layer disposed on the current collector. The positive electrode active material layer may include the above-described solid electrolyte and positive electrode active material, and may optionally further include a binder and/or a conductive material.

Since the solid electrolyte included in the positive electrode may need to well penetrate between the positive electrode active material particles to increase ion conductivity and energy density, the solid electrolyte in the positive electrode may have an average particle diameter (D50) of, e.g., about 1.0 μm or less, e.g., about 0.1 μm to about 1.0 μm, about 0.1 μm to about 0.9 μm, or about 0.1 μm to about 0.8 μm. The solid electrolyte having the particle diameter range may effectively penetrate between the positive electrode active materials to achieve excellent contact with the positive electrode active materials and secure excellent connectivity between the solid electrolyte particles and thus increase pellet density and energy density of the positive electrode.

The sulfide-based solid electrolyte may be characterized to exhibit that the smaller particle diameter and the larger specific surface area, the more vulnerable to moisture. Accordingly, as the solid electrolyte with a small particle diameter may be applied to the positive electrode, the solid electrolyte according to some example embodiments may be applied, since moisture stability may not be only improved, but also interfacial resistance with the positive electrode active material may be lowered, to manufacture a positive electrode having excellent performance.

A content of the solid electrolyte in the positive electrode for the all-solid-state battery may be about 0.1 wt % to about 35 wt %, e.g., about 1 wt % to about 35 wt %, about 5 wt % to about 30 wt %, about 8 wt % to about 25 wt %, or about 10 wt % to about 20 wt %. This is a content based on a total weight of the components in the positive electrode, and specifically, it may be referred to as a content based on a total weight of the positive electrode active material layer.

In addition, in the positive electrode for an all-solid-state battery, about 65 wt % to about 99 wt % of the positive electrode active material and about 1 wt % to about 35 wt % of the solid electrolyte, e.g., about 80 wt % of the positive electrode active material and about 80 wt % to about 90 wt % and about 10 wt % to about 20 wt % of the solid electrolyte based on the total weight of the positive electrode active material and the solid electrolyte may be included. If the solid electrolyte is included in the positive electrode in such a content, the efficiency and cycle-life characteristics of the all-solid-state battery may be improved without reducing the capacity.

Positive Electrode Active Material

In some example embodiments, the positive electrode active material may be applicable without limitation as long as it may be generally used in a rechargeable lithium battery or an all-solid-state battery. In an implementation, the positive electrode active material may be a compound capable of reversible intercalation and deintercalation of lithium (lithiated intercalation compound), and may include a compound represented by one of the following chemical formulas.

LiₐA_{1-b}X_{b}D₂(0.90≤a≤1.8, 0≤b≤0.5);

LiₐA_{1-b}X_{b}O_{2-c}D_{c}(0.90≤a≤1.8, 0≤b≤0.5, 0≤c≤0.05);

LiₐE_{1-b}X_{b}O_{2-c}D_{c}(0.90≤a≤1.8, 0≤b≤0.5, 0≤c≤0.05);

LiₐE_{2-b}X_{b}O_{4-c}D_{c}(0.90≤a≤1.8, 0≤b≤0.5, 0≤c≤0.05);

LiₐNi_{1-b-c}Co_{b}X_{c}D_{c}, (0.90≤a≤1.8, 0≤b≤0.5, 0≤c≤0.05, 0≤α≤2);

LiₐNi_{1-b-c}Co_{b}X_{c}O_{2-α}T_{α}(0.90≤a≤1.8, 0≤b≤0.5, 0≤c≤0.05, 0≤α≤2);

LiₐNi_{1-b-c}Co_{b}X_{c}O_{2-α}T₂(0.90≤a≤1.8, 0≤b≤0.5, 0≤c≤0.05, 0≤α≤2);

LiₐNi_{1-b-c}Mn_{b}X_{c}D_{α}(0.90≤a≤1.8, 0≤b≤0.5, 0≤c≤0.05, 0≤α≤2);

LiₐNi_{1-b-c}Mn_{b}X_{c}O_{2-α}T_{α}(0.90≤a≤1.8, 0≤b≤0.5, 0≤c≤0.05, 0≤α≤2);

LiₐNi_{1-b-c}Mn_{b}X_{c}O_{2-α}T₂(0.90≤a≤1.8, 0≤b≤0.5, 0≤c≤0.05, 0≤α≤2);

LiₐNi_{b}E_{c}G_{d}O₂(0.90≤a≤1.8, 0≤b≤0.9, 0≤c≤0.5, 0.001≤d≤0.1);

LiₐNi_{b}Co_{c}Mn_{d}GₑO₂(0.90≤a≤1.8, 0≤b≤0.9, 0≤c≤0.5, 0≤d≤0.5, 0.001≤e≤0.1);

LiₐNiG_{b}O₂(0.90≤a≤1.8, 0.001≤b≤0.1);

LiₐCoG_{b}O₂(0.90≤a≤1.8, 0.001≤b≤0.1);

LiₐMn_{1-b}G_{b}O₂(0.90≤a≤1.8, 0.001≤b≤0.1);

LiₐMn₂G_{b}O₄(0.90≤a≤1.8, 0.001≤b≤0.1);

LiₐMn_{1-g}G_{g}PO₄(0.90≤a≤1.8, 0≤g≤0.5);

QO₂;QS₂;LiQS₂;

V₂O₅;LiV₂O₅;

LiZO₂;

LiNiVO₄;

Li_{(3-f)}J₂(PO₄)₃(0≤f≤2);

Li_{(3-f)}Fe₂(PO₄)₃(0≤f≤2);

LiₐFePO₄(0.90≤a≤1.8).

In the chemical formulas, A may be, e.g., Ni, Co, Mn, or a combination thereof; X may be, e.g., Al, Ni, Co, Mn, Cr, Fe, Mg, Sr, V, rare earth elements, or a combination thereof; D may be, e.g., O, F, S, P, or a combination thereof; E may be, e.g., Co, Mn, or a combination thereof; T may be, e.g., F, S, P, or a combination thereof; G may be, e.g., Al, Cr, Mn, Fe, Mg, La, Ce, Sr, V, or a combination thereof; Q may be, e.g., Ti, Mo, Mn, or a combination thereof; Z maybe, e.g., Cr, V, Fe, Sc, Y, or a combination thereof; and J may be, e.g., V, Cr, Mn, Co, Ni, Cu, or a combination thereof.

The positive electrode active material may be, e.g., a lithium-metal composite oxide or a lithium-metal composite phosphate, and the metal may be Al, Co, Fe, Mg, Ni, Mn, V, or the like. The positive electrode active material may be, e.g., a lithium cobalt oxide (LCO), a lithium nickel oxide (LNO), a lithium nickel cobalt oxide (NC), a lithium nickel cobalt aluminum oxide (NCA), a lithium nickel cobalt manganese oxide (NCM), a lithium manganese oxide (LMO), or lithium iron phosphate (LFP).

In an implementation, the positive electrode active material may include a lithium nickel-based composite oxide represented by Chemical Formula 1, which may be capable of realizing high capacity, high energy density, and the like.

Liₐ₁Niₓ₁M¹_{y1}M²_{1-x1-y1}O₂ [Chemical Formula 1]

In Chemical Formula 1, 0.9≤a1≤1.8, 0.3≤x1≤1, 0≤y1≤0.7, and M¹ and M² may each independently be one or more element, e.g., Al, B, Ba, Ca, Ce, Co, Cr, Cu, F, Fe, Mg, Mn, Mo, Nb, P, S, Si, Sr, Ti, V, W, or Zr.

In Chemical Formula 1, 0.3≤x1≤1 and 0≤y1≤0.7, or 0.4≤x1≤1 and 0≤y1≤0.6, or 0.5≤x1≤1 and 0≤y1≤0.5, or 0.6≤x1≤1 and 0≤y1≤0.4, 0.7≤x1≤1 and 0≤y1≤0.3, 0.8≤x1≤1 and 0≤y1≤0.2, 0.85≤x1≤1 and 0≤y1≤0.15, or 0.9≤x1≤1 and 0≤y1≤0.1.

The positive electrode active material may include, e.g., lithium nickel-cobalt-based oxide represented by Chemical Formula 2.

Liₐ₂Niₓ₂Co_{y2}M³_{1-x2-y2}O₂ [Chemical Formula 2]

In Chemical Formula 2, 0.9≤a2≤1.8, 0.3≤x2≤1 and 0≤y2≤0.7, and M³ may be one or more elements, e.g., Al, B, Ba, Ca, Ce, Co, Cr, Cu, F, Fe, Mg, Mn, Mo, Nb, P, S, Si, Sr, Ti, V, W, or Zr.

In Chemical Formula 2, 0.3≤x2≤0.99 and 0.01≤y2≤0.7, or 0.4≤x2≤0.99 and 0.01≤y2≤0.6, or 0.5≤x2≤0.99 and 0.01≤y2≤0.5, or 0.6≤x2≤0.99 and 0.01≤y2≤0.4, or 0.7≤x2≤0.99 and 0.01≤y2≤0.3, 0.8≤x2≤0.99 and 0.01≤y2≤0.2, or 0.9≤x2≤0.99 and 0.01≤y2≤0.1.

The positive electrode active material may be, e.g., a high-nickel-based positive electrode active material, and in this case, a rechargeable lithium battery having high capacity, high power, and high energy density may be implemented. The high-nickel-based positive electrode active material based on the total amount of elements other than lithium and oxygen in the lithium-nickel-based composite oxide may have a nickel content of greater than or equal to about 80 mol %, e.g., greater than or equal to about 85 mol %, greater than or equal to about 89 mol %, greater than or equal to about 90 mol %, greater than or equal to about 91 mol % or greater than or equal to about 94 mol %, and less than or equal to about 99.9 mol %, or less than or equal to about 99 mol %. If the nickel content satisfies the above range, the positive electrode active material may exhibit excellent battery performance while realizing high capacity.

An average particle diameter (D50) of the positive electrode active material may be about 1 μm to about 25 μm, e.g., about 4 μm to about 25 about 5 μm to about 20 about 8 μm to about 20 or about 10 μm to about 18 μm. A positive electrode active material having such a particle size range may be harmoniously mixed with other components in a positive electrode active material layer and may realize high capacity and high energy density.

The positive electrode active material may be in the form of secondary particles formed by aggregating a plurality of primary particles, or may be in the form of single particles. In addition, the positive electrode active material may have a spherical or near-spherical shape, or may have a polyhedral or amorphous shape.

Binder

The binder may serve to well attach the positive electrode active material particles and the solid electrolyte particles to each other, and also to well attach the particles to the current collector. Examples of the binder may include, e.g., polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, or nylon.

The binder may be included in an amount of about 0.1 wt % to about 5 wt %, or about 0.1 wt % to about 3 wt % based on the total weight of each component of the positive electrode for an all-solid-state battery or the total weight of the positive electrode active material layer. Within the above content range, the binder may sufficiently exhibit adhesive ability without deteriorating battery performance.

Conductive Material

The conductive material may be used to impart conductivity to the electrode, and may include, e.g., a carbon-based material such as natural graphite, artificial graphite, carbon black, acetylene black, Ketjen black, a carbon fiber, a carbon nanotube, and the like; a metal-based material containing copper, nickel, aluminum, silver and the like and in the form of a metal powder or a metal fiber; a conductive polymer such as a polyphenylene derivative; or a combination thereof.

The conductive material may be included in an amount of about 0.1 wt % to about 5 wt %, or about 0.1 wt % to about 3 wt % based on a total weight of each component of the positive electrode for an all-solid-state battery or a total weight of the positive electrode active material layer. In the above content range, the conductive material may improve electrical conductivity without degrading battery performance.

Meanwhile, the positive electrode for a rechargeable lithium battery may further include an oxide-based inorganic solid electrolyte in addition to the aforementioned solid electrolyte. The oxide-based inorganic solid electrolyte may include, e.g., Li₁₊ₓTi₂₋ₓAl(PO₄)₃ (LTAP) (0≤x≤4), Li_{1+x+y}AlₓTi₂₋ₓSi_{y}P_{3-y}O₁₂(0<x<2, 0≤y≤3), BaTiO₃, Pb(Zr, Ti)O₃ (PZT), Pb₁₋ₓLaₓZr_{1-y}Ti_{y}O₃ (PLZT) (0≤x≤1, 0≤y≤1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂(0≤x≤1, 0≤y≤1), lithium lanthanum titanate (Liₓ La_{y}TiO₃, 0<x<2, 0<y<3), Li₂O, LiAlO₂, Li₂O—Al₂O₃—SiO₂—P₂O₅—TiO₂—GeO₂-based ceramics, Garnet-based ceramics Li₃₊ₓLa₃M₂O₁₂ (wherein M may be Te, Nb, or Zr; x may be an integer of 1 to 10), or a combination thereof.

All-solid-state Battery

In some example embodiments, the all-solid-state rechargeable battery may include a positive electrode, a negative electrode, and a solid electrolyte layer between the positive electrode and the negative electrode, wherein the positive electrode and/or the solid electrolyte layer may include the aforementioned solid electrolyte. The all-solid-state rechargeable battery may also be referred to as an all-solid-state battery or an all-solid-state rechargeable lithium battery. The all-solid-state rechargeable battery according to some example embodiments may include the aforementioned solid electrolyte, so that high capacity and high energy density may be realized while initial efficiency may be improved due to high ion conductivity, and long-term cycle-life characteristics may be improved.

The aforementioned solid electrolyte may be included in the positive electrode active material layer of the positive electrode, or may be included in the solid electrolyte layer, or both.

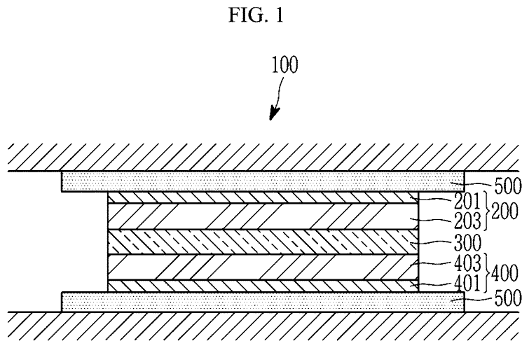

FIG. 1 shows a cross-sectional view of an all-solid-state battery according to some example embodiments. Referring to FIG. 1, the all-solid-state battery 100 may have a structure that an electrode assembly, in which a negative electrode 400 including a negative current collector 401 and a negative electrode active material layer 403, a solid electrolyte layer 300, and a positive electrode 200 including a positive electrode active material layer 203 and a positive current collector 201 may be stacked, may be inserted into a case such as a pouch and the like. The all-solid-state battery 100 may further include at least one elastic layer 500 on the outside of at least either one of the positive electrode 200 and the negative electrode 400. FIG. 1 shows one electrode assembly including the negative electrode 400, the solid electrolyte layer 300, and the positive electrode 200, but two or more electrode assemblies may be stacked to manufacture an all-solid-state battery.

Since the positive electrode for an all-solid-state battery is as described above, a detailed description thereof will be omitted.

Negative Electrode

The negative electrode for an all-solid-state battery may include, e.g., a current collector and a negative electrode active material layer on the current collector. The negative electrode active material layer may include a negative electrode active material, and may further include a binder, a conductive material, and/or a solid electrolyte.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, e.g., crystalline carbon, amorphous carbon, or a combination thereof as a carbon-based negative electrode active material. The crystalline carbon may be non-shaped, or sheet, flake, spherical, or fiber shaped natural graphite or artificial graphite. The amorphous carbon may be a soft carbon, a hard carbon, a mesophase pitch carbonization product, calcined coke, and the like.

The lithium metal alloy may include an alloy of lithium and one or more metal, e.g., Na, K, Rb, Cs, Fr, Be, Mg, Ca, Sr, Si, Sb, Pb, In, Zn, Ba, Ra, Ge, Al, or Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (wherein Q may be an alkali metal, an alkaline-earth metal, a Group 13 element, a Group 14 element, a Group 15 element, a Group 16 element, a transition metal, a rare earth element, and a combination thereof, but not Si) and the Sn-based negative electrode active material may include Sn, SnO₂, a Sn—R alloy (wherein R may be an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may be, e.g., Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof.

The silicon-carbon composite may be, e.g., a silicon-carbon composite including a core including crystalline carbon and silicon particles and an amorphous carbon coating layer disposed on the surface of the core. The crystalline carbon may be artificial graphite, natural graphite, or a combination thereof. The amorphous carbon precursor may be a coal-based pitch, mesophase pitch, petroleum-based pitch, coal-based oil, petroleum-based heavy oil, or a polymer resin such as a phenol resin, a furan resin, or a polyimide resin. In this case, the content of silicon may be about 10 wt % to about 50 wt % based on the total weight of the silicon-carbon composite. In addition, the content of the crystalline carbon may be about 10 wt % to about 70 wt % based on the total weight of the silicon-carbon composite, and the content of the amorphous carbon may be about 20 wt % to about 40 wt % based on the total weight of the silicon-carbon composite. In addition, a thickness of the amorphous carbon coating layer may be about 5 nm to about 100 nm.

The average particle diameter (D50) of the silicon particles may be about 10 nm to about 20 μm, e.g., about 10 nm to about 500 nm. The silicon particles may be present in an oxidized form, and at this time, an atomic content ratio of Si:O in the silicon particle indicating a degree of oxidation may be about 99:1 to about 33:67. The silicon particles may be SiOₓ particles, and in this case, the range of x in SiOₓ may be greater than about 0 and less than about 2. The average particle diameter (D50) may be measured by a microscope image or a particle size analyzer, and may mean a diameter (D50) of particles having a cumulative volume of 50 volume % in a particle size distribution.

The Si-based negative electrode active material or Sn-based negative electrode active material may be mixed with the carbon-based negative electrode active material. A mixing ratio of the Si-based negative electrode active material or Sn-based negative electrode active material with the carbon-based negative electrode active material may be a weight ratio of about 1:99 to about 90:10.

In the negative electrode active material layer, the negative electrode active material may be included in an amount of about 95 wt % to about 99 wt % based on the total weight of the negative electrode active material layer.

In some example embodiments, the negative electrode active material layer may further include a binder, and may optionally further include a conductive material. The content of the binder in the negative electrode active material layer may be about 1 wt % to about 5 wt % based on the total weight of the negative electrode active material layer. In addition, if the conductive material is further included, the negative electrode active material layer may include about 90 wt % to about 98 wt % of the negative electrode active material, about 1 wt % to about 5 wt % of the binder, and about 1 wt % to about 5 wt % of the conductive material.

The binder may serve to well adhere the negative electrode active material particles to each other and also to adhere the negative electrode active material to the current collector. The binder may be a water-insoluble binder, a water-soluble binder, or a combination thereof.

The water-insoluble binder may include, e.g., polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may be, e.g., a styrene-butadiene rubber, an acrylated styrene-butadiene rubber, an acrylonitrile-butadiene rubber, an acrylic rubber, a butyl rubber, a fluororubber, or a combination thereof. The polymer resin binder may be, e.g., polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, or a combination thereof.

If a water-soluble binder is used as the negative electrode binder, a thickener capable of imparting viscosity may be used together, and the thickener may include, e.g., a cellulose-based compound. The cellulose-based compound may include carboxymethyl cellulose, hydroxypropylmethyl cellulose, methyl cellulose, an alkali metal salt thereof, or a combination thereof. The alkali metal may be Na, K, or Li. The amount of the thickener used may be about 0.1 parts by weight to about 3 parts by weight based on 100 parts by weight of the negative electrode active material.

The conductive material may be included to impart conductivity to the electrode, and may include, e.g., a carbon-based material such as natural graphite, artificial graphite, carbon black, acetylene black, Ketjen black, a carbon fiber, carbon nanotube, and the like; a metal-based material of a metal powder or a metal fiber including copper, nickel, aluminum silver, and the like; a conductive polymer such as a polyphenylene derivative; or a mixture thereof.

The negative current collector may include, e.g., a copper foil, a nickel foil, a stainless steel foil, a titanium foil, a nickel foam, a copper foam, a polymer substrate coated with a conductive metal, or a combination thereof.

As another example, the negative electrode for the all-solid-state battery may be a precipitation-type negative electrode. The precipitation-type negative electrode may be a negative electrode which has no negative electrode active material during the assembly of a battery but in which a lithium metal and the like are precipitated during the charge of the battery and serve as a negative electrode active material.

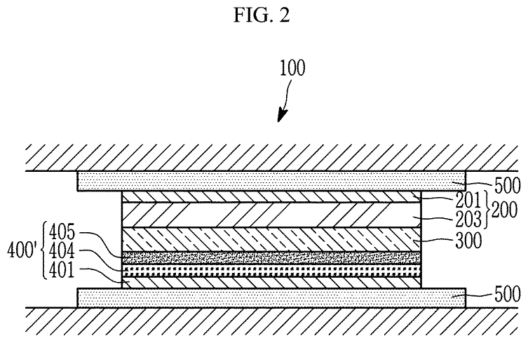

FIG. 2 shows a schematic cross-sectional view of an all-solid-state battery including a precipitation-type negative electrode. Referring to FIG. 2, the precipitation-type negative electrode 400′ may include the current collector 401 and a negative electrode catalyst layer 405 disposed on the current collector. The all-solid-state battery having this precipitation-type negative electrode 400′ may start to be initially charged in absence of a negative electrode active material, and a lithium metal with high density and the like may be precipitated between the current collector 401 and the negative electrode catalyst layer 405 during the charge and form a lithium metal layer 404, which may work as a negative electrode active material. Accordingly, the precipitation-type negative electrode 400′, in the all-solid-state battery which is more than once charged, may include the current collector 401, the lithium metal layer 404 on the current collector, and the negative electrode catalyst layer 405 on the metal layer 404. The lithium metal layer 404 may mean a layer of the lithium metal and the like precipitated during the charge of the battery and may be called to be a metal layer, a negative electrode active material layer, or the like.

The negative electrode catalyst layer 405 may include a metal, a carbon material, or a combination thereof which plays a role of a catalyst.

The metal may include, e.g., gold, platinum, palladium, silicon silver, aluminum, bismuth, tin, zinc, or a combination thereof and may be composed of one selected therefrom or an alloy of more than one. If the metal is present in particle form, an average particle diameter (D50) thereof may be less than or equal to about 4 μm, e.g., about 10 nm to about 4 μm.

The carbon material may be, e.g., crystalline carbon, amorphous carbon, or a combination thereof. The crystalline carbon may be, e.g., natural graphite, artificial graphite, mesophase carbon microbeads, or a combination thereof. The amorphous carbon may be, e.g., carbon black, activated carbon, acetylene black, Denka black, Ketjen black, or a combination thereof.

If the negative electrode catalyst layer 405 includes the metal and the carbon material, the metal and the carbon material may be, e.g., mixed in a weight ratio of about 1:10 to about 2:1. Herein, the precipitation of the lithium metal may be effectively promoted and may improve characteristics of the all-solid-state battery. The negative electrode catalyst layer 405 may include, e.g., a carbon material on which a catalyst metal is supported or a mixture of metal particles and carbon material particles.

The negative electrode catalyst layer 405 may include, e.g., the metal and amorphous carbon, and in this case, the deposition of lithium metal may be effectively promoted.

The negative electrode catalyst layer 405 may further include a binder, and the binder may be a conductive binder. In addition, the negative electrode catalyst layer 405 may further include general additives such as a filler, a dispersant, and an ion conducting agent.

The negative electrode catalyst layer 405 may have a thickness of, e.g., about 100 nm to about 20 μm, about 500 nm to about 10 μm, or about 1 μm to about 5 μm.

The precipitation-type negative electrode 400′ may further include a thin film, e.g., on the surface of the current collector, that is, between the current collector and the negative electrode catalyst layer. The thin film may include an element capable of forming an alloy with lithium. The element capable of forming an alloy with lithium may be, e.g., gold, silver, zinc, tin, indium, silicon, aluminum, bismuth, and the like, which may be used alone or an alloy of more than one. The thin film may further planarize a precipitation shape of the lithium metal layer 404 and may much improve characteristics of the all-solid-state battery. The thin film may be formed, e.g., in a vacuum deposition method, a sputtering method, a plating method, and the like. The thin film may have, e.g., a thickness of about 1 nm to about 500 nm.

Solid Electrolyte Layer

The solid electrolyte layer 300 may include the aforementioned solid electrolyte, or may include other types of sulfide-based solid electrolytes, oxide-based solid electrolytes, and the like, in addition to or together with the aforementioned solid electrolytes. Details of the sulfide-based solid electrolyte and the oxide-based solid electrolyte are as described above.

In one example, the solid electrolyte included in the positive electrode 200 and the solid electrolyte included in the solid electrolyte layer 300 may include the same compound or different compounds. In an implementation, if both the positive electrode 200 and the solid electrolyte layer 300 include an argyrodite-type sulfide-based solid electrolyte, overall performance of the all-solid-state rechargeable battery may be improved. In addition, e.g., if both the positive electrode 200 and the solid electrolyte layer 300 include the aforementioned coated solid electrolyte, the all-solid-state rechargeable battery may implement excellent initial efficiency and cycle-life characteristics while implementing high capacity and high energy density.

Meanwhile, the average particle diameter (D50) of the solid electrolyte included in the positive electrode 200 may be smaller than the average particle diameter (D50) of the solid electrolyte included in the solid electrolyte layer 300. In this case, overall performance may be improved by increasing the mobility of lithium ions while maximizing the energy density of the all-solid-state battery. In an implementation, the average particle diameter (D50) of the solid electrolyte included in the positive electrode 200 may be about 0.1 μm to about 1.0 or about 0.1 μm to about 0.8 and the average particle diameter (D50) of the solid electrolyte included in the solid electrolyte layer 300 may be about 1.5 μm to about 5.0 or about 2.0 μm to about 4.0 or about 2.5 μm to about 3.5 If the particle size ranges are satisfied, the energy density of the all-solid-state rechargeable battery may be maximized while the transfer of lithium ions may be facilitated, so that resistance may be suppressed, and thus the overall performance of the all-solid-state rechargeable battery may be improved. Herein, the average particle diameter (D50) of the solid electrolyte may be measured through a particle size analyzer using a laser diffraction method. Alternatively, about 20 particles may be arbitrarily selected from a micrograph of a scanning electron microscope or the like, the particle size may be measured, and a particle size distribution may be obtained, and the D50 value may be calculated.

The solid electrolyte layer may further include a binder in addition to the solid electrolyte. Herein, the binder may include a styrene butadiene rubber, polytetrafluoroethylene, polyvinylidene fluoride, polyethylene, an acrylate-based polymer, or a combination thereof. The acrylate-based polymer may be, e.g., butyl acrylate, polyacrylate, polymethacrylate, or a combination thereof.

The solid electrolyte layer may be formed by adding a solid electrolyte to a binder solution, coating it on a base film, and drying the resultant. The solvent of the binder solution may be isobutyl isobutyrate, xylene, toluene, benzene, hexane, or a combination thereof. Since a forming process of the solid electrolyte layer is well known in the art, a detailed description thereof will be omitted.

A thickness of the solid electrolyte layer may be, e.g., about 10 μm to about 150 μm.

The solid electrolyte layer may further include an alkali metal salt and/or an ionic liquid and/or a conductive polymer.

The alkali metal salt may be, e.g., a lithium salt. A content of the lithium salt in the solid electrolyte layer may be greater than or equal to about 1 M, e.g., about 1 M to about 4 M. In this case, the lithium salt may improve ion conductivity by improving lithium ion mobility of the solid electrolyte layer.

The lithium salt may include, e.g., LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃ (C₂F₅), lithium bis(oxalato) borate (LiBOB), lithium oxalyldifluoroborate (LIODFB), lithium difluoro(oxalato) borate (LiDFOB), lithium bis(trifluoromethanesulfonyl)imide LiTFSI, LiN(SO₂CF₃)₂, lithium bis(fluorosulfonyl)imide (LiF SI, LiN(SO₂F)₂), LiCF₃SO₃, LiAsF₆, LiSbF₆, LiCO₄, or a mixture thereof.

In addition, the lithium salt may be an imide-based salt, e.g., the imide-based lithium salt may be lithium bis(trifluoromethanesulfonyl) imide (LiTF SI, LiN(SO₂CF₃)₂), and lithium bis(fluorosulfonyl)imide (LiFSI, LiN(SO₂F)₂). The lithium salt may maintain or improve ion conductivity by appropriately maintaining chemical reactivity with the ionic liquid.

The ionic liquid may have a melting point below room temperature, so it may be in a liquid state at room temperature and may refer to a salt or room temperature molten salt composed of ions alone.

The ionic liquid may be a compound including a cation, e.g., an ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, triazolium-based, or a mixture thereof, and an anion, e.g., BF₄—, PF₆—, AsF₆—, SbF₆—, AlCl₄—, HSO₄—, ClO₄—, CH₃SO₃—, CF₃CO₂—, Cl—, Br—, I—, SO₄—, CF₃SO₃—, (FSO₂)₂N—, (C₂F₅SO₂)₂N—, (C₂F₅SO₂)(CF₃SO₂)N—, or (CF₃SO₂)₂N—.

The ionic liquid may be, e.g., N-methyl-N-propylpyrrolidinium bis(trifluoromethanesulfonyl)imide N-butyl-N-methylpyrrolidium bis(3-trifluoromethylsulfonyl)imide, 1-butyl-3-methylimidazolium bis(trifluoromethylsulfonyl)amide, or 1-ethyl-3-methylimidazolium bis(trifluoromethylsulfonyl)amide.

A weight ratio of the solid electrolyte and the ionic liquid in the solid electrolyte layer may be about 0.1:99.9 to about 90:10, e.g., about 10:90 to about 90:10, about 20:80 to about 90:10, about 30:70 to about 90:10, about 40:60 to about 90:10, or about 50:50 to about 90:10. The solid electrolyte layer satisfying the above ranges may maintain or improve ion conductivity by improving the electrochemical contact area with the electrode. Accordingly, the energy density, discharge capacity, rate capability, etc. of the all-solid-state battery may be improved.

The all-solid-state battery may be a unit cell having a structure of a positive electrode/solid electrolyte layer/negative electrode, a bicell having a structure of positive electrode/solid electrolyte layer/negative electrode/solid electrolyte layer/positive electrode, or a stacked battery in which the structure of the unit cell is repeated.

The shape of the all-solid-state battery is not particularly limited, and may be, e.g., a coin type, a button type, a sheet type, a stack type, a cylindrical shape, a flat type, and the like. In addition, the all-solid-state battery may be applied to a large-sized battery used in an electric vehicle or the like. In an implementation, the all-solid-state battery may also be used in a hybrid vehicle such as a plug-in hybrid electric vehicle (PHEV). In addition, it may be used in a field requiring a large amount of power storage, and may be used, e.g., in an electric bicycle or a power tool.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

1. Preparation of Sulfide-based Solid Electrolyte Particles

An argyrodite-type sulfide-based solid electrolyte is synthesized through a method described later. All processes of mixing raw materials and pre- and post-heat treatments are performed in a glove box under an argon atmosphere. Specifically, the raw materials of lithium sulfide (Li₂S), phosphorus pentasulfide (P₂S₅), and lithium chloride (LiCl) are mixed in a molar ratio of 2.5:0.5:1, preparing mixed powder. The mixed powder is uniformly mixed with a Henschel mixer and then, primarily fired at 250° C. for 5 hours in a tube furnace through which argon gas is flowing at a constant speed of 8 SLM.

The primarily fired powder is uniformly mixed again with the Henschel mixer, sifted, and then, secondarily fired at 500° C. for 10 hours in the tube furnace through which argon gas is flowing at the constant speed of 8 SLM. The secondarily fired powder is pulverized and sifted, obtaining sulfide-based solid electrolyte particles of Li₆PS₅Cl. This obtained sulfide-based solid electrolyte particles had a size (D50) of 0.85 μm.

2. Coating of Sulfide-based Solid Electrolyte Particles

After diluting vanadium oxytriisopropoxide in a hexane solvent, the prepared sulfide-based solid electrolyte particles are added thereto and then, mixed. Herein, a content of the vanadium oxytriisopropoxide is 10 parts by weight based on 100 parts by weight of the sulfide-based solid electrolyte particles. After mixing the obtained mixture for 10 minutes and removing the solvent, a product therefrom is dried at 25° C. for 30 minutes to prepare a solid electrolyte coated with the vanadium alkoxide. The coated vanadium is about 2 wt % based on 100 wt % of the solid electrolyte.

3. Manufacture of Positive Electrode

A positive electrode active material composition is prepared by adding 83.8 wt % of a positive electrode active material, 14.8 wt % of the prepared solid electrolyte, 0.9 wt % of a polyvinylidene fluoride binder, 0.5 wt % of a carbon nanotube conductive material, and 0.1 wt % of a dispersant in an isobutyl isobutyrate (IBIB) solvent. This composition is coated on a positive electrode current collector and dried to manufacture a positive electrode.

4. Manufacture of Solid Electrolyte Layer

To an argyrodite-type solid electrolyte (Li₆PS₅Cl, D50=3 μm), an IBIB solvent including an acryl-based binder is added and then, mixed. Herein, while mixing, the solvent is added to secure appropriate viscosity and thus prepare slurry. The slurry is cast on a releasing film and dried at 70° C. for 2 hours to prepare a solid electrolyte layer.

5. Preparation of Negative Electrode

A negative electrode catalyst layer composition is prepared by mixing carbon black having a primary particle diameter of about 30 nm, silver (Ag) having an average particle diameter (D50) of about 60 nm in a weight ratio of 3:1 to prepare a catalyst and then, adding 0.25 g of the catalyst to 2 g of an NMP solution including 7 wt % of a polyvinylidene fluoride binder. This composition is coated on a negative electrode current collector and dried to manufacture a precipitation-type negative electrode having a negative electrode catalyst layer.

6. Manufacture of All-solid-state Battery Cell

The prepared positive electrode, negative electrode, and solid electrolyte layer are cut, and after stacking the solid electrolyte layer on the positive electrode, the negative electrode is stacked thereon. This stack is sealed into a pouch shape and pressed with a warm isostatic press (WIP) at 500 Mpa for 30 minutes at 80° C. to manufacture an all-solid-state battery cell.

### Example 2

A solid electrolyte and an all-solid-state battery cell are manufactured in the same manner as in Example 1 except that the content of the vanadium oxytriisopropoxide is changed into 20 parts by weight to prepare the solid electrolyte.

### Example 3

A solid electrolyte and an all-solid-state battery cell are manufactured in the same manner as in Example 1 except that the content of the vanadium oxytriisopropoxide is changed into 30 parts by weight to prepare the solid electrolyte.

### Example 4

A solid electrolyte and all-solid-state battery cell are manufactured in the same manner as in Example 1 except that titanium ethoxide is used instead of the vanadium oxytriisopropoxide when coating the solid electrolyte.

### Comparative Example 1

A solid electrolyte and all-solid-state battery cell are manufactured in the same manner as in Example 1 except that Li₆PS₅Cl prepared without coating the metal alkoxide on the sulfide-based solid electrolyte particles is used as the solid electrolyte. Evaluation Example 1: Evaluation of Change of Ion Conductivity of Solid

### Electrolyte

Each of the solid electrolytes according to Comparative Example 1 and Examples 1 and 2 is measured with respect to ion conductivity (0 day; Od) and remeasured with respect to the ion conductivity after being allowed to stand for 3 days (3d) and 1 week (1w) in a dry room at a dew point temperature of −45° C., and the results are shown in Table 1. The ion conductivity is measured through electrochemical impedance spectroscopy (EIS) at amplitude of 10 mV and a frequency of 0.01 Hz to 1 MHz at 45° C.

TABLE 1

| | Comparative | | | | | | | | |
|---|---|---|---|---|---|---|---|---|---|
| | Example 1 | | | Example 1 | | | Example 2 | | |
| | @0 d | @3 d | @1 w | @0 d | @3 d | @1 w | @0 d | @3 d | @1 w |
| Ion | 1.95 | 1.45 | 0.65 | 0.92 | 0.81 | 0.61 | 0.64 | 0.56 | 0.48 |
| con- | | (74%) | (33%) | | (88%) | (66%) | | (88%) | (75%) |
| ductivity | | | | | | | | | |
| (mS/cm) | | | | | | | | | |

Referring to Table 1, the ion conductivity of Comparative Example 1 exhibits each retention rate of 74% and 33% after being allowed to stand respectively for 3 days and 1 week, but the ion conductivity of Example 1 exhibits each retention rate of about 88% and 66%, and the ion conductivity of Example 2 exhibits each retention rate of about 88% and 75%, in which the ion conductivity is all maintained at a high level. Accordingly, the example embodiments, in which the solid electrolytes are protected by a metal alkoxide coating layer, exhibit improved moisture stability and thus are suppressed from sharp deterioration of the ion conductivity with time.

### Evaluation Example 2: Evaluation of all-Solid-State Rechargeable Battery Cells

The all-solid-state rechargeable battery cells according to Comparative Example 1 and Examples 1 to 4 are charged to an upper voltage limit of 4.25 Vat a constant current of 0.1 C and discharged to a discharge cut-off voltage of 2.5 V at 0.1 C at 45° C. to measure 0.1 C charge capacity and 0.1 C discharge capacity and then, calculate a ratio of the 0.1 C discharge capacity to the 0.1 C charge capacity as initial charge and discharge efficiency, and the results are shown in Table 2.

Subsequently, the cells are charged under the same conditions but discharged at 0.33 C to measure capacity and then, charged under the same conditions and discharged at 1.0 C to measure capacity and then, calculate a ratio (1 C/0.33 C) of the 1.0 C discharge capacity to the 0.33 C discharge capacity as rate characteristics, and the rate characteristic results are shown in Table 2.

Then, the cells are charged under the same conditions and discharged at 0.1 C to measure capacity and then, calculate a ratio (0.1 C/0.1 C) of the 0.1 C discharge capacity to the initial 0.1 C discharge capacity, and the results are shown as 0.1 C discharge capacity recovery characteristics in Table 2.

In addition, the cells are measured with respect to DC-IR in SOC (state of charge) of 50%, and the results are shown in Table 2.

TABLE 2

| | Com- | | | | | | | | | |
|---|---|---|---|---|---|---|---|---|---|---|
| | parative | | | | | | | | | |
| | Example 1 | | Example 1 | | Example 2 | | Example 3 | | Example 4 | |
| | @0 d | @3 d | @1 w | @0 d | @3 d | @1 w | @0 d | @3 d | @1 w | @0 d |
| 0.1 C charge | 225 | 229 | 224 | 226 | 230 | 239 | 233 | 226 | 229 | 234 |
| (mAh/g) | | | | | | | | | | |
| 0.1 C discharge | 202 | 206 | 202 | 201 | 206 | 217 | 203 | 202 | 206 | 209 |
| (mAh/g) | | | | | | | | | | |
| Initial efficiency (%) | 90 | 90 | 90 | 89 | 90 | 91 | 87 | 89 | 90 | 90 |
| 0.33 C discharge | 187 | 190 | 187 | 186 | 186 | 201 | 174 | 181 | 188 | 193 |
| (mAh/g) | | | | | | | | | | |
| 1.0 C discharge | 173 | 176 | 172 | 173 | 169 | 185 | 149 | 156 | 173 | 178 |
| (mAh/g) | | | | | | | | | | |
| 1.0 C/0.33 C (%) | 92 | 92 | 92 | 93 | 91 | 92 | 85 | 86 | 92 | 92 |
| 0.1 C discharge | 194 | 196 | 193 | 194 | 193 | 208 | 177 | 191 | 192 | 199 |
| (mAh/g) | | | | | | | | | | |
| 0.1 C/0.1 C (%) | 96 | 95 | 95 | 97 | 94 | 96 | 88 | 94 | 93 | 95 |
| DCIR@SOC50(Ω) | 30 | 49 | 33 | 34 | 42 | 26 | 56 | 52 | 27 | 28 |

Referring to Table 2, Comparative Example 1 exhibits initial 0.1 C discharge capacity of 202 mAh/g, and Examples 1 to 4 exhibit each improved discharge capacity of 202, 206, 203, and 206 mAh/g. In particular, in the evaluation of the all-solid-state rechargeable battery cell using the solid electrolyte allowed to stand for 3 days, Comparative Example 1 exhibits 206 mAh/g @ 0.1 C, but Examples 2 and 4 exhibit high discharge capacity of 217 and 209 mAh/g. Subsequently, Examples 2 and 4 express much improved discharge capacity characteristics of 201 and 193 mAh/g @ 0.33 C and 185 and 178 mAh/g @ 1.0 C at the 0.33 C and 1.0 C discharges. In addition, in the DC-IR evaluation at SOC of 50%, Comparative Example 1 exhibits 4952, but Examples 2 and 4 exhibit 2652 and 2852, which are reduced DC-IR resistance.

Through Tables 1 and 2, in the evaluations of ion conductivity of the solid electrolyte coated with metal alkoxide after being allowed to stand and the all-solid-state rechargeable battery cell, the solid electrolyte coated with metal alkoxide exhibits much improved results. Accordingly, the metal alkoxide coating layer coated in the solid electrolyte turns out to function to protect the solid electrolyte from external moisture.

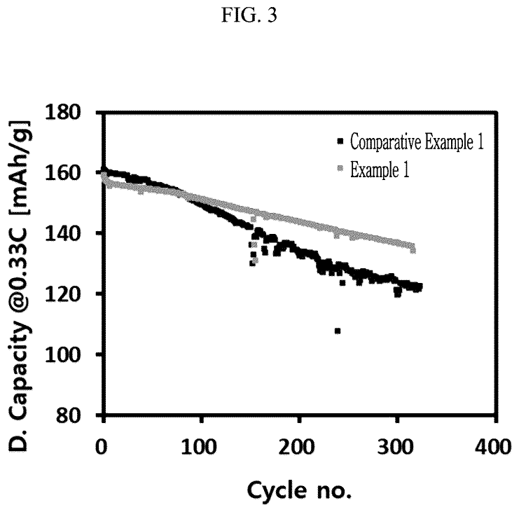

On the other hand, the solid electrolytes of Comparative Example 1 and Example 1, after being allowed to stand for 3 days, are respectively used to manufacture an all-solid-state rechargeable battery cell, and the all-solid-state rechargeable battery cells are repeatedly charged within a voltage range of 2.5 V to 4.25 Vat 0.33 C and discharged at 0.33 C at 45° C. to evaluate cycle-life characteristics, and FIG. 3 is a discharge capacity graph according to the number of cycles. Referring to FIG. 3, compared with Comparative Example 1, Example 1 exhibits improved cycle characteristics.

By way of summation and review, solid electrolytes may have lower ion conductivity than liquid electrolytes and generate resistance on the interface between solid electrolyte particles or on the interface with a positive electrode active material and the like in the battery and thus may have problems of deteriorating ion conductivity performance and the like.

Among the solid electrolytes, research on a sulfide-based solid electrolyte having relatively high ion conductivity is being actively performed. However, the sulfide-based solid electrolyte may have difficulties in handling due to the low moisture stability. In an implementation, the sulfide-based solid electrolyte, when manufactured, moved, or inserted into a battery, may be defected or corroded by a side reaction on the surface due to moisture in the air.

The sulfide-based solid electrolyte may be coated to protect the surface of the sulfide-based solid electrolyte and thus lower the interfacial resistance in the battery, but the coating has been reported to cause problems of defecting, corroding, or aggregating the sulfide-based solid electrolyte particles.

In addition, in order to lower the interfacial resistance of the solid electrolytes, technologies of doping various elements or forming a buffer layer on positive electrode active material particles used with the solid electrolytes may be considered but also may have difficulties in mass production, cost and environmental problems, and a limit in improving performance of all-solid-state rechargeable batteries.

A solid electrolyte capable of suppressing defects of a sulfide-based solid electrolyte and increasing moisture stability and a preparing method thereof, and an all-solid-state rechargeable battery including the same having improved cycle-life characteristics and safety are provided herein.

The solid electrolyte according to some example embodiments may include sulfide-based solid electrolyte particles and a coating layer on the surface of the particles, and during the coating process, defects of the sulfide-based solid electrolyte particles may not occur or may be substantially minimized, and a stable coating layer capable of effectively protecting the surface of the particles may be formed, thereby increasing the water stability of the solid electrolyte and improving ion conductivity. An all-solid-state rechargeable battery to which this is applied may realize high cycle-life characteristics and secure safety.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A solid electrolyte, comprising:
sulfide-based solid electrolyte particles; and
a coating layer disposed on a surface of the sulfide-based solid electrolyte particles and including a metal alkoxide.

2. The solid electrolyte as claimed in claim 1, wherein:
the metal alkoxide includes a metal, and
the metal includes one or more elements selected from Nb, Sb, Ti, V, or Zr.

3. The solid electrolyte as claimed in claim 1, wherein an amount of the metal alkoxide is about 0.1 wt % to about 50 wt % based on 100 wt % of the solid electrolyte.

4. The solid electrolyte as claimed in claim 1, wherein an amount of the metal alkoxide is about 5 wt % to about 25 wt % based on 100 wt % of the solid electrolyte.

5. The solid electrolyte as claimed in claim 1, wherein the coating layer further includes a metal oxide containing the same metal as the metal of the metal alkoxide.

6. The solid electrolyte as claimed in claim 1, wherein a thickness of the coating layer is about 5 nm to about 1 μm.

7. The solid electrolyte as claimed in claim 1, wherein the sulfide-based solid electrolyte particles include an argyrodite-type sulfide.

8. The solid electrolyte as claimed in claim 7, wherein the argyrodite-type sulfide includes Li₃PS₄, Li₇P₃S₁₁, Li₇PS₆, Li₆PS₅Cl, Li₆PS₅Br, Li₅₈PS_{4.8}Cl_{1.2}, Li_{6.2}PS_{5.2}Br_{0.8} or a combination thereof.

9. The solid electrolyte as claimed in claim 1, wherein an average particle diameter (D50) of the solid electrolyte is about 0.1 μm to about 5.0 μm.

10. A method of preparing a solid electrolyte, the method comprising:
adding sulfide-based solid electrolyte particles to a solution including a metal alkoxide and a solvent to mix them;
removing the solvent; and
drying a product obtaining a solid electrolyte including sulfide-based solid electrolyte particles and a coating layer disposed on a surface of the particles and including a metal alkoxide.

11. The method of preparing a solid electrolyte as claimed in claim 10, wherein:
the metal alkoxide includes a metal, and
the metal includes one or more elements selected from Nb, Sb, Ti, V, or Zr.

12. The method of preparing a solid electrolyte as claimed in claim 10, wherein a content of the metal alkoxide is about 0.1 parts by weight to about 50 parts by weight based on 100 parts by weight of the sulfide-based solid electrolyte particles.

13. The method of preparing a solid electrolyte as claimed in claim 10, wherein a content of the metal alkoxide is about 5 parts by weight to about 25 parts by weight based on 100 parts by weight of the sulfide-based solid electrolyte particles.

14. The method of preparing a solid electrolyte as claimed in claim 10, wherein the solvent includes pentane, hexane, heptane, benzene, toluene, xylene, acetic acid, diethyl ether, ethyl acetate, pyridine, or a combination thereof.

15. The method of preparing a solid electrolyte as claimed in claim 10, wherein the sulfide-based solid electrolyte particle includes an argyrodite-type sulfide.

16. The method of preparing a solid electrolyte as claimed in claim 15, wherein the argyrodite-type sulfide includes Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8} or a combination thereof.

17. The method of preparing a solid electrolyte as claimed in claim 10, wherein the drying is performed at about 20° C. to about 70° C.

18. The method of preparing a solid electrolyte as claimed in claim 10, wherein an average particle diameter (D50) of the obtained solid electrolyte is about 0.1 μm to about 5.0 μm.

19. A positive electrode for an all-solid-state rechargeable battery, comprising:
the solid electrolyte as claimed in claim 1; and
a positive electrode active material.

20. An all-solid-state rechargeable battery, comprising:
a positive electrode;
a negative electrode; and
a solid electrolyte layer between the positive electrode and the negative electrode,
wherein the positive electrode and/or the solid electrolyte layer includes the solid electrolyte according to claim 1.
